(19) United States
(12) Patent Application Publication
(10) Pub. No.: US 2005/0281981 A1
(43) Pub. Date: Dec. 22, 2005

(54) Fixtures and methods for facilitating the fabrication of devices having thin film materials

(76) Inventors: Raymond Puffer, Watervliet, NY (US); Stephen Derby, Troy, NY (US); Glenn Saunders, East Greenbush, NY (US); Glen Hoppes, Frankfurt (DE); Louise Courtois, Granby, MA (US); Jurgen Pawlik, Neuzeilsheim (DE); Werner Kraus, Niedernhjausen (DE)

Correspondence Address: CONNOLLY BOVE LODGE & HUTZ, LLP, P O BOX 2207, WILMINGTON, DE, 19899, US

(21) Appl. No.: 10/525,806

(22) PCT Filed: Aug. 20, 2003
(86) PCT No.: PCT/EP03/09200

§ 371 Date: Feb. 25, 2005

Related U.S. Application Data
(60) Provisional application No. 60/407,115, filed on Aug. 30, 2002.

(51) Int. Cl. B32B 3/10

(52) U.S. Cl. 428/137

(57) ABSTRACT

Fixtures and methods of using fixtures to facilitate the fabrication of devices having thin films, for example, gasketed components of fuel-cell membrane electrode assemblies, are disclosed. In one aspect, the fixture comprises a plate having an aperture and means for mounting a thin film to the plate wherein the thin film at least partially obstructs the aperture and wherein the thin film provides a surface for mounting at least one component of a device. Another aspect is a fixture for facilitating the fabrication of a fuel-cell membrane electrode assembly which includes a plate having an aperture and means for mounting a gasket to the plate wherein the gasket at least partially obstructs the aperture and wherein the gasket provides a surface for mounting at least one electrode for a fuel-cell membrane electrode assembly.

### REFERENCE TO RELATED APPLICATIONS

This application draws priority from U.S. Provisional Patent Application 60/407,115 filed on Aug. 30, 2002 (attorney ref. 2036.002P). The disclosure of this Provisional Patent Application is incorporated by reference herein in its entirety. This application is also related to commonly-assigned U.S. patent application Ser. No. 10/232,424 filed on Aug. 30, 2002 and entitled “METHOD AND APPARATUS FOR TRANSFERRING THIN FILMS FROM A SOURCE POSITION TO A TARGET POSITION” (Attrny. Ref. 2036.001), the disclosure of which is included by reference herein in its entirety.

### TECHNICAL FIELD

This invention relates generally to fixtures and methods used for fabricating devices having one or more components mounted on thin films, for example, on thin-film gaskets. Specifically, the present invention provides improved methods and apparatus for fabricating components of membrane electrode assemblies for fuel cells having electrodes mounted on thin-film gaskets.

### BACKGROUND OF THE INVENTION

Thin film-like materials are handled in many different types of industries, for example, in photographic and x-ray film manufacture and processing, membrane manufacture and processing, packaging, printing, and electronics, among others. The thin, flexible, and often fragile nature of film-like materials typically requires special considerations when handling these materials, for example, to prevent tearing, distortion, and breakage, and to ensure proper orientation and alignment during assembly.

One field in which the handling of thin film-like materials is often problematic is the field of fuel cells, for example, during the handling and assembly of electrodes mounted on thin-film gaskets found in Membrane Electrode Assemblies (or MEAs). MEAs typically consist of several layers of thin materials (that is, materials having a thickness of about 0.001 inches) which are assembled with layer-to-layer registration or alignment tolerances of a few thousandths of an inch. In some types of MEAs, the MEA typically includes two layers of gasket material, two electrodes, and one membrane, for example, a proton exchange membrane (PEM). These components are typically cut to appropriate size and assembled with dimensional tolerances of a few thousandths of an inch. Typically, prior art MEA assembly processes consists of several diverse operations that must be performed in a prescribed sequence, typically requiring the materials to be transported between assembly stations during processing. The handling of the components of the MEA, for example, the thin gaskets, the thin electrodes, and the thin membrane is typically hampered by the flexibility and fragility that characterizes these thin materials. The highly-toleranced alignment or registration required between components during the assembly of MEAs and MEA components typically hampers the repeated positioning and repositioning of the components as the components are transported from work station to work station.

According to the prior art, MEAs are typically assembled by hand, one at a time. In order for fuel cells to become economically viable it is preferred that the fabrication and assembly of the components of MEAs and the MEAs themselves be automated. However, the transport and registration (that is, alignment) of multiple layers of thin film materials presents a particularly difficult challenge for prior art fabrication methods. According to one aspect of the present invention, fabrication fixtures and fabrication methods are provided which overcome the disadvantages of the prior art methods of fabricating components of MEAs which are particularly useful in automating the fabrication process.

### SUMMARY OF THE INVENTION

The present invention provides methods and apparatus which address many of the limitations of prior art methods and apparatus.

One aspect of the invention is a fixture for facilitating the fabrication of a fuel-cell membrane electrode assembly, the fixture including: a plate having an aperture; and means for mounting a gasket to the plate wherein the gasket at least partially obstructs the aperture; wherein the portion of the gasket that at least partially obstructs the aperture provides a surface for mounting at least one electrode for a fuel-cell membrane electrode assembly. In one aspect of the invention, the means for mounting the gasket to the plate comprises means for detachably mounting the gasket to the plate. In one aspect of the invention, the means for mounting the gasket to the plate comprises at least one of mechanical means, adhesive means, magnetic means, and vacuum means. For example, mechanical means includes soldering, brazing, welding, and mechanical fasteners, among others; adhesive means includes glues, epoxies, and adhesive tapes, among others; magnetic means includes the use of one or more magnets or magnetized surfaces; vacuum means includes the application of vacuum from a source of vacuum. In one aspect of the invention, the means for mounting the gasket to the plate comprises at least one magnet. In another aspect of the invention, the means for mounting the gasket to the plate further comprises at least one ferro-magnetic plate that is attracted to the at least one magnet. In one aspect of the invention, the fixture further comprises at least one vacuum aperture in the plate operatively connected to a source of vacuum. In another aspect of the invention, the fixture further comprises at least one vacuum channel in fluid communication with the at least one vacuum aperture. In one aspect of the invention, the plate comprises at least one of a metallic and a non-metallic material, for example, a composite material. In another aspect of the invention, the gasket comprises a thin-film gasket having a thickness of less than about 500 microns. In another aspect of the invention, the gasket comprises a thin-film gasket having a thickness of less than about 200 microns.

Another aspect of the invention is a method for facilitating the fabrication of fuel-cell membrane electrode assemblies using a fixture comprising a first plate having an aperture, the method including the steps of: a) providing a thin-film gasket; b) mounting the thin-film gasket to the first plate wherein the thin-film gasket at least partially obstructs the aperture; c) introducing an aperture to the thin-film gasket; and d) mounting an electrode over the aperture in the thin-film gasket to provide a first gasketed electrode mounted in the first plate; wherein the gasketed electrode is used in a fuel-cell membrane electrode assembly. In one aspect of the invention, the first plate further comprises means for attaching the thin-film gasket to the first plate, and wherein b) mounting the thin-film gasket to the first plate comprises mounting the thin-film gasket using the means for attaching the thin film gasket of the first plate. In another aspect of the invention, the step c) introducing an aperture in the thin-film gasket comprises introducing a quadrilateral aperture in the thin-film gasket, for example, by die-cutting the aperture in the thin-film gasket. In one aspect of the invention, the step c) introducing an aperture in the thin-film gasket comprises introducing a plurality of apertures in the thin-film gasket. In another aspect of the invention, the step d) mounting the electrode over the aperture in the thin-film gasket comprises d1) overlapping at least a portion of the electrode and the thin-film gasket, and d2) heating and compressing the overlapped portion to provide adhesion between the overlapped portion of the thin-film gasket and the overlapped portion of the electrode. In one aspect of the invention, the step d2) heating and compressing comprises heating to at least about 100 degrees C. and compressing to at least about 100 psi.

In another aspect of the invention, the method further comprises repeating steps a) through d) to provide a second gasketed electrode mounted in a second plate. In one aspect of the invention, the method further comprises positioning an exchange membrane between the first gasketed electrode and the second gasketed electrode and sealing the first gasketed electrode and the second gasketed electrode about the exchange membrane to produce a sealed gasketed electrode-membrane-electrode assembly. In one aspect of the invention, sealing comprises exposing the first gasketed electrode and the second gasketed electrode to temperature and pressure wherein the first gasketed electrode and the second gasketed electrode adhere to the exchange membrane. In another aspect of the invention, the method further comprises laminating the gasketed electrode-membrane-electrode assembly, for example, exposing at least a portion of the gaskets of the first gasketed electrode and the second gasketed electrode to temperature and pressure wherein the portion of the gaskets adhere to each other. In one aspect of the invention, the method further comprises introducing at least one aperture to the gasket of the gasketed electrode-membrane-electrode assembly to provide a passage for a gas when assembled in a fuel cell stack. In another aspect of the invention, the method further comprises positioning the gasketed electrode-membrane-electrode assembly in a fuel cell stack.

Another aspect of the invention is a fixture for facilitating the fabrication of devices having thin films, the fixture comprising: a plate having an aperture; and means for mounting a thin film to the plate wherein the thin film at least partially obstructs the aperture; wherein the portion of the thin film that at least partially obstructs the aperture provides a surface for mounting at least one component of the device. In one aspect of the invention, the means for mounting the thin film to the plate comprises means for detachably mounting the thin film to the plate, for example, at least one of mechanical means, magnetic means, and vacuum means. In another aspect of the invention, the means for mounting the thin film to the plate comprises at least one magnet. In one aspect of the invention, the means for mounting the thin film to the plate further comprises at least one ferro-magnetic plate that is attracted to the at least one magnet. In one aspect of the invention, the fixture further comprises at least one vacuum aperture in the plate operatively connected to a source of vacuum. In one aspect of the invention, the fixture further comprises at least one vacuum channel in fluid communication with the at least one vacuum aperture. In one aspect of the invention, the plate comprises at least one of a metallic and a non-metallic material, for example, a composite material. In one aspect of the invention, the thin film comprises a thin film having a thickness of less than about 1 millimeter. In another aspect of the invention, the thin film comprises a thin film having a thickness of less than about 500 microns. In another aspect of the invention, the thin film comprises a thin film having a thickness of less than about 200 microns.

A further aspect of the invention is a method for facilitating the fabrication of devices having thin films using a fixture comprising a plate having an aperture, the method including the steps of: a) providing the thin film; b) mounting the thin film to the plate wherein the thin film at least partially obstructs the aperture; c) mounting at least one component of the device on the thin film to provide a component with a thin film supported by the plate; d) exposing the component with a thin film to further processing while supported by the plate; and e) mounting the component with the thin film in the device.

In one aspect of the invention, the method further comprises the step f) introducing at least one aperture to the thin film, for example, by die-cutting the aperture in the thin film. In another aspect of the invention, the plate further comprises means for attaching the thin film to the plate, and wherein b) mounting the thin film to the plate comprises mounting the thin film using the means for attaching the thin film to the plate. In one aspect of the invention, the plate further comprises at least one magnet, and the step b) mounting the thin film to the plate comprises positioning the thin film over the at least one magnet and placing a ferro-magnet plate over the thin film and the at least one magnet. In another aspect of the invention, the step c) mounting at least one component of the device on the thin film comprises c1) overlapping at least a portion of the component and the thin-film, and c2) heating and compressing the overlapped portion to provide adhesion between the overlapped portion of the thin-film and the overlapped portion of the component. In one aspect of the invention, the step c2) heating and compressing comprises heating to at least about 100 degrees C. and compressing to at least about 100 psi.

These and other embodiments and aspects of the present invention will become more apparent upon review of the attached drawings, description below, and attached claims.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following detailed descriptions of the preferred embodiments and the accompanying drawings in which:

FIG. 1 is a perspective view of a fixture for retaining a thin film according to one aspect of the present invention.

FIGS. 2A, 2B, and 2C, are cross-sectional views of the fixture shown in FIG. 1 as viewed along lines 2-2 in FIG. 1 according to one aspect of the present invention.

FIG. 3 is an exploded perspective view of a fixture for retaining a thin film according to one aspect of the present invention.

FIG. 4 is an assembled perspective view of the fixture shown in FIG. 3 according to one aspect of the present invention.

FIG. 5 is an assembled perspective view of the fixture shown in FIG. 4 having excess film trimmed according to one aspect of the present invention.

FIG. 6 is a perspective view of a fixture retaining a thin film having an aperture according to one aspect of the present invention.

FIG. 7 is cross-sectional view of the fixture shown in FIG. 6 as viewed along lines 7-7 in FIG. 6 showing the placement of an electrode on the thin film according to one aspect of the present invention.

FIG. 8 is cross-sectional view similar to FIG. 7 showing the mounting of an electrode on the thin film according to one aspect of the present invention.

FIG. 9 is an exploded perspective view of an assembly of the two of the fixtures shown in FIG. 8 and a membrane according to one aspect of the present invention.

FIG. 10 is a perspective view of the fixtures of FIG. 9 as assembled according to one aspect of the present invention.

FIG. 11 is cross-sectional view of the fixture shown in FIG. 10 as viewed along lines 11-11 in FIG. 10 according to one aspect of the present invention.

FIG. 12 is a detailed view of the electrode-membrane-electrode assembly shown in FIG. 11 prior to sealing according to one aspect of the present invention.

FIG. 13 is a detailed view of the electrode-membrane-electrode assembly shown in FIG. 11 after sealing according to one aspect of the present invention.

FIG. 14 is a perspective view of the fixture shown in FIG. 10 with the introduction of gas passages according to one aspect of the present invention.

FIG. 15 is a perspective view of a membrane electrode assembly after it is removed from the fixture shown in FIG. 14 according to one aspect of the present invention.

FIG. 16 is a plan view of a fixture having a single aperture with multiple electrodes according to one aspect of the present invention.

FIG. 17 is a plan view of a fixture having multiple apertures with single electrodes according to one aspect of the present invention.

FIG. 18 is a plan view of another fixture having multiple apertures with single electrodes according to one aspect of the present invention.

FIG. 19 is a plan view of a circular fixture having a circular aperture with a single circular electrode according to one aspect of the present invention.

FIG. 20 is a plan view of a fixture having a single aperture and also having a means for facilitating the mounting of a thin film to the fixture according to one aspect of the present invention.

FIG. 21 is cross-sectional view of the fixture shown in FIG. 20 as viewed along lines 21-21 in FIG. 20 according to one aspect of the present invention.

### DETAILED DESCRIPTION OF THE PREFERRED EMBODIMENTS

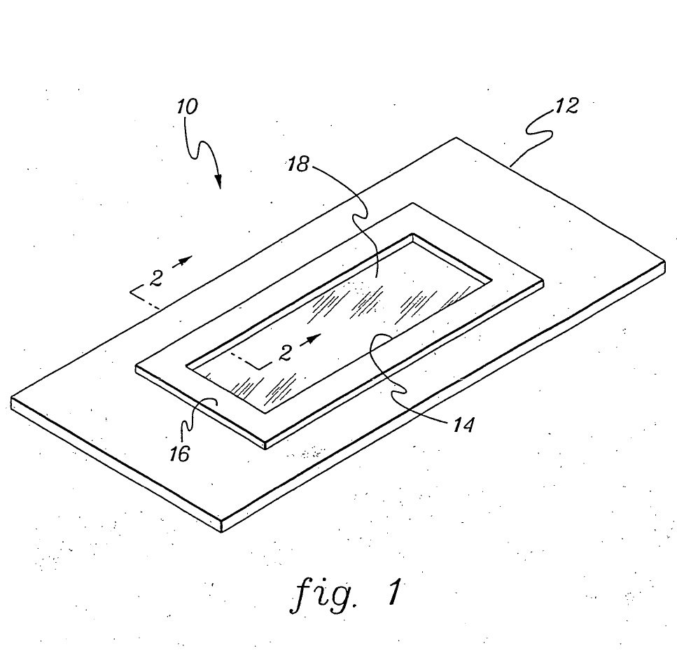

FIG. 1 illustrates a perspective view of a fixture 10 according to one aspect of the present invention. Fixture 10 includes a plate 12 having an aperture 14 and a means 16 for mounting a thin, film-like material 18, for example, a thin-film gasket material, at least partially over the aperture 14. According to this aspect of the invention, fixture 10 provides a platform for mounting, transporting, or manipulating components which are mounted on thin film-like materials. According to one aspect of the present invention, fixture 10 may be used for mounting, transporting, or manipulating components used in fuel cell assemblies which are mounted on thin-film gaskets, for example, fabric-electrodes mounted on thin dielectric gaskets. However, the present invention may be used in any industry to facilitate the handling of components mounted on thin films during fabrication, assembly, or use. These industries include, but are not limited to, the semiconductor industry, the medical industry, the food-handling industry, the materials industry, the materials handling industry, the chemical industry, the photography industry, the printing industry, specialty garment industry (for example, hazardous material protection) and the aircraft manufacturing industry (for example, for composite material manufacture), among others.

According to the aspect of the invention shown in FIG. 1, plate 12 may be any flat thin piece of material, for example, a material that provides stiffness to minimize deflection and also is light weight to facilitate handling. Plate 12 may be made from wood, for example, hardwood board or plywood; glass; metal, for example, steel, stainless steel, aluminum, or titanium, among others; plastic, for example, polyethylene, polypropylene, polycarbonate, or polyester; or a composite material, such as a carbon composite provided by Vermont Composites of Bennington, Vt. The structure of plate 12 may also take many forms, for example, to provide the desired stiffness and low weight, for example, plate 12 may include stiffening ribs, that is, longitudinal or transverse ribs; or plate 12 may be of hollow construction having internal cavities or stiffeners for example, honeycombed aluminum or other extruded or fabricated construction.

The illustration of the various aspects of the present invention shown in the figures is intended to illustrate the aspects of the present invention as clearly as possible. Since some of the structures are relatively thin in cross-section, for example, the thin film 18 in FIG. 1, for the sake of clarity, the dimensions (most notably the thickness) of these structures may be exaggerated, that is, not drawn to scale. The text of this specification provides ranges of dimensions for most structures that should be relied upon when the depictions in the figures are not to scale.

The dimensions of plate 12 may vary depending upon the size of the components being handled by fixture 10. Plate 12 may have a length and a width that varies from about 1 inch (25.4 mm) to about 20 feet (about 6 meters), depending upon the application. For example, in the aspect of the invention used to handle components of MEAs for fuel cells, plate 12 may have a length and a width that may range from about 1 foot (about 300 mm) to about 6 feet (about 2 meters). In one aspect of the invention, plate 12 has a length of between about 2 feet (about 610 mm) and about 4 feet (about 1.2 meters) and a width of between about 1 foot (about 300 mm) and about 3 feet (about 914 mm). The thickness of plate 12 may also vary broadly depending upon the material of construction and the weight of the components being handled by fixture 10. The thickness of plate 12 may range from about 1 mm (0.039 inches) to about 100 mm (about 4 inches), and typically ranges between about 3 mm (about 0.125 inches) to about 12 mm (about 0.50 inches).

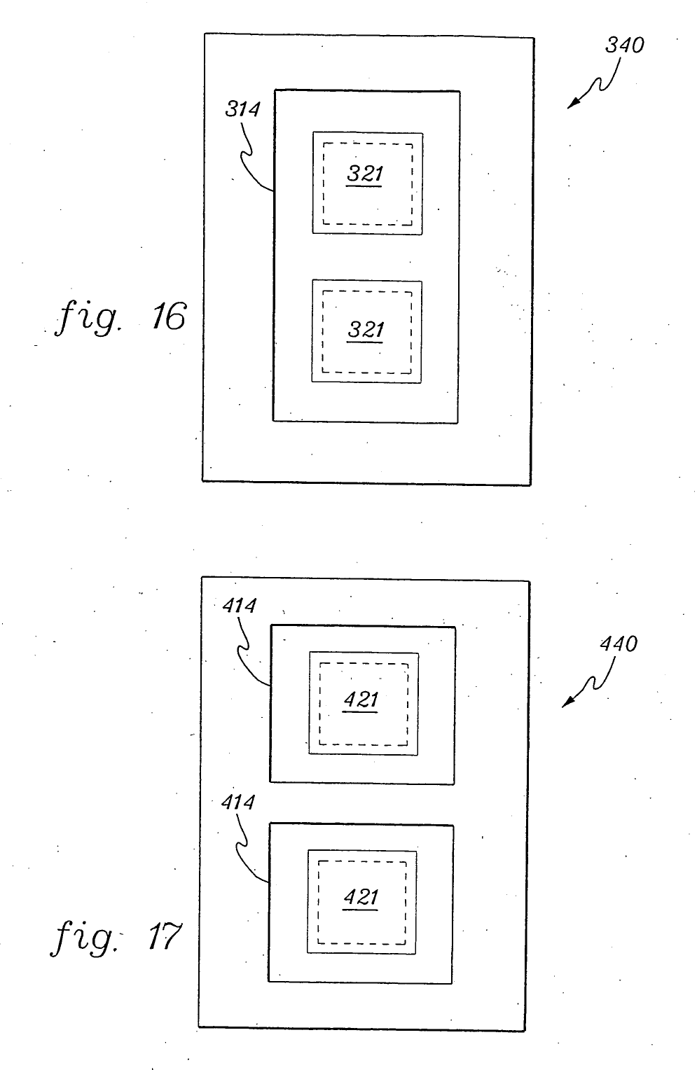

Aperture 14 may take any size or shape depending upon the size, weight, and number of components, among other things, being handled by fixture 10. Aperture 12 may be rectangular, square, round, triangular, or ellipsoidal, among other shapes. According to one aspect of the invention, more than one aperture 14 may be provided in plate 12 (for example, see FIGS. 16 and 17). According to one aspect of the invention, aperture 14 comprises a single aperture, centrally located within plate 12. In another aspect of the invention, one or more apertures 14 may be off-set from the centerlines of plate 12.

Thin, film like material 18 may be any of a broad range of materials that may be used to mount a component. Thin film 18 may be a metallic or non-metallic film or sheet, for example, thin film 18 may be metallic foil, such as gold, aluminum, tin, or steel foil. Thin film 18 may be a plastic or polymeric film, such as polyethylene (PE) or polyester (PET). In one aspect of the invention, thin film 18 may be any of a number of high temperature stable polymers such as a polyimide film, for example, a polyimide film sold under the trademark Kapton® by Dupont. In one aspect of the invention, thin film 18 may be any member of the family of polyetherketones (e.g., PEK, PEEK, etc.) or polytetrafluoroethylenes (PTFE or FEP) which are used as a dielectric gasket material in an MEA. Thin film 18 may also have a broad range of thickness, according to the present invention, depending upon what component is being handled by fixture 10. In one aspect of the invention, thin film 18 may have a thickness that ranges from about 1 micrometer (about 0.00004 inches) to about 500 micrometers (about 0.020 inches), and may typically have a thickness that ranges from about 25 micrometers (about 0.001 inches) to about 200 micrometers (about 0.008 inches).

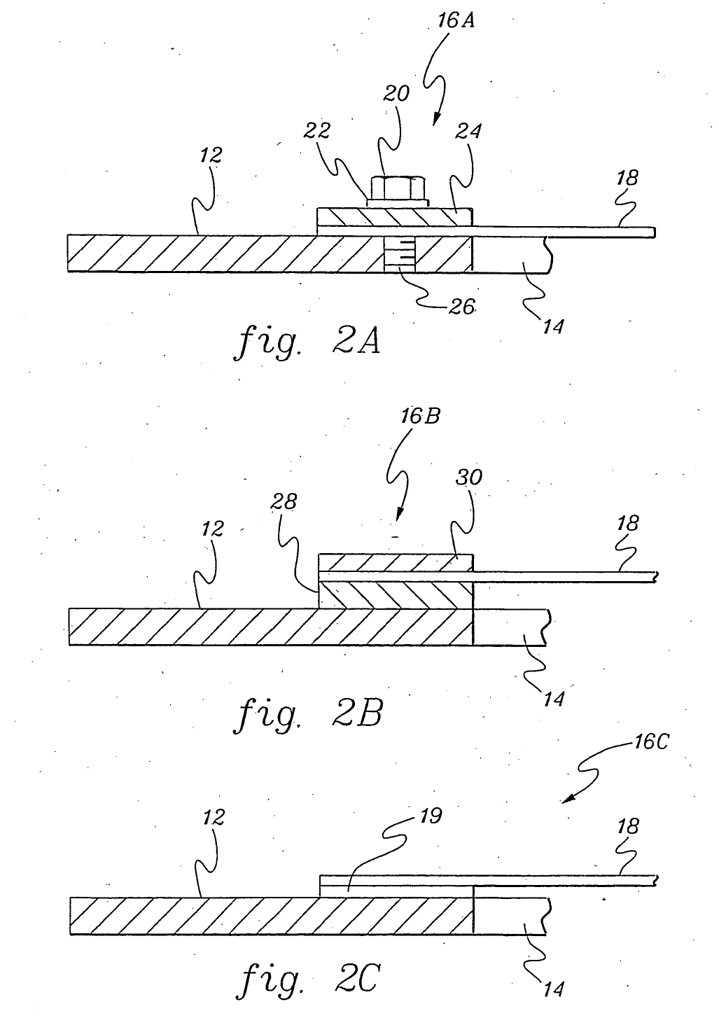

The means 16 for mounting the thin, film-like material 18 may include any structure that can retain film 18 on fixture 10 when film 18 is exposed to the desired handling and loading. Three embodiments of means 16 are illustrated in FIGS. 2A, 2B, and 2C. FIGS. 2A, 2B, and 2C illustrate cross-sectional views of means 16 taken along the view lines 2-2 shown in FIG. 1. According to one aspect of the invention, shown in FIG. 2A, means 16A comprises a plurality of mechanical fasteners, for example, screws 20 and washers 22 and one or more retaining plates 24. In this aspect of the invention, screws 22 are threaded into threaded holes 26 in plate 12 and screws 20, washers 22, and one or more retaining plates 24 retain film 18 about aperture 14 in plate 12. In one aspect of the invention, instead of screws 22, nuts and bolts may be used to retain film 18. The length and thickness of plate 24 may vary depending upon the size of fixture 10 and the size and weight of the component being retained in fixture 10. For example, the width of plate 24 may range from 0.125 inches (about 3 mm) to about 3 feet (about 1 meter). In one aspect of the invention, where the present invention is used to handle components of MEAs of fuel cells, the width of plate 24 may range from about 0.5 inches to about 3 inches, for example, between about 1 and about 2 inches. The thickness of plate 24 may range from about 0.1 mm (about 0.004 inches) to about 50 mm (about 2 inches), and may typically be between about 0.5 mm (about 0.02 inches) and about 5 mm (about 0.2 inches). In one aspect of the invention, plate 24 has a width of about 1 inch (about 25.4 mm) and a thickness of about 0.5 mm (about 0.02 inches).

In the aspect of the invention shown in FIG. 2B, means 16B retains thin film 18 across aperture 14 of plate 12. In this aspect of the invention, means 16B includes one or more magnets 28 and one or more ferro-magnetic plates 30 which retain film 18. One or more magnets 28 may be any type of conventional magnet, including a permanent magnet or an electromagnet. In one aspect of the invention, magnets 28 are elastomeric magnets, for example, magnets comprising ferro-magnetic particles imbedded in an elastomeric matrix. Magnets 28 may be attached to plate 12 by conventional means, including mechanical fasteners or adhesives, among others. Plate 30 may be any type of plate that is attracted to magnets 28 with sufficient force to retain film 18, for example, a carbon steel plate or stainless steel plate. Plate 30 may also be a plate comprising ferro-magnetic particles in a non-metallic matrix, for example, a plastic or an elastomeric material impregnated with ferrous particles. In one aspect of the invention, magnets 28 may be embedded in plate 12, for example, wherein the surface of magnets 28 is essentially flush with the surface of plate 12. The surface of embedded magnets 28 may also not be flush with the surface of plate 12, but may be above or below the surface of plate 12. In one aspect of the invention, magnets 28 are molded into the surface of plate 12. In another aspect of the invention, magnets 28 comprise regions of plate 12 that have been magnetized, for example, electro-magnetized.

In one aspect of the invention, plate 12 may be a ferrous material and film 18 may be retained by one or more detachable magnets 28′ (not shown) without the need for plate 30. In this aspect of the invention, film 18 is retained on plate 12 by means of the magnetic attraction between detachable magnets 28′ and plate 12.

The length and thickness of magnet 28 and plate 30 may vary depending upon the size of fixture 10 and the size and weight of the component being retained in fixture 10. For example, the width of magnet 28 and plate 30 may range from 0.125 inches (about 3 mm) to about 3 feet (about 1 meter). In one aspect of the invention, where the present invention is used to handle components of MEAs of fuel cells, the width of magnet 28 and plate 30 may range from about 0.25 inches (about 6 mm) to about 3 inches (about 75 mm), for example, between about 1 (25.4 mm) and about 2 inches (50.8 mm). The thickness of magnet 28 and plate 30 may range from about 0.1 mm (about 0.004 inches) to about 50 mm (about 2 inches), and is typically between about 0.5 mm (about 0.02 inches) to about 5 mm (about 0.2 inches). In one aspect of the invention, magnet 28 has a width of about 1 inch (about 25.4 mm) and a thickness of about 2.5 mm (about 0.10 inches) and plate 30 has a width of about 1 inch (about 25.4 mm) and a thickness of about 0.5 mm (about 0.02 inches). The width of plate 30 may be about equal to, greater than or less than the width of magnet 28.

In the aspect of the invention shown in FIG. 2C, means 16C retains thin film 18 across aperture 14 of plate 12. In this aspect of the invention, means 16C may include some form of bonding 19 between thin film 18 and plate 12. For example, bonding 19 may be an adhesive, for example, a permanent adhesive or a temporary adhesive (such as the temporary adhesive used in Post-it® brand adhesive notes) or tape, for example, single-sided or double-sided tape. Bonding 19 may also comprise a fusion of film 18 with plate 12, for example, a thermal fusion or welding. The thermal fusion of film 18 and plate 12 may be effected by exposing the mating surfaces to temperature and pressure. Bonding 19 may comprise other conventional means of bonding a thin film 18 to a plate 18.

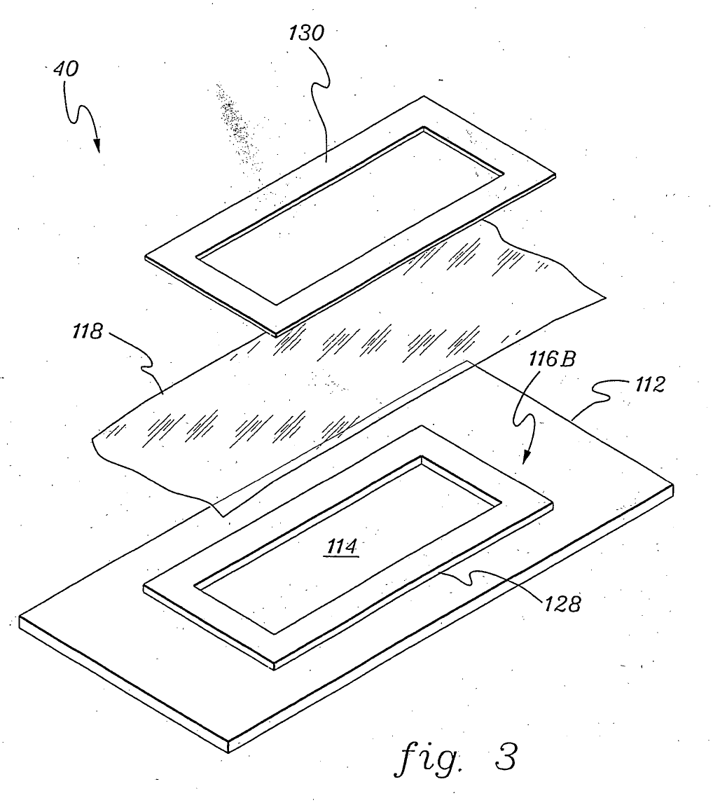

FIG. 3 illustrates an exploded perspective view of fixture 40 according to one aspect of the invention shown in FIG. 1. In the aspect of the invention shown in FIG. 3, fixture 40 includes a plate 112 (similar to plate 12) having aperture 114 (similar to aperture 14), and a means 116B (similar to means 16B shown in FIG. 2B) for retaining thin film 118 (similar to film 18). In this aspect of the invention, aperture 114 is a rectangular and means 116B includes a rectangular arrangement of magnets 128 mounted about aperture 114. Means 116B also includes a retaining plate 130 (similar to retaining plate 30 shown in FIG. 2B). Retaining plate 130 may be a single plate or two or more plates. In this aspect of the invention, plate 130 has substantially the same geometry as magnets 128. According to one aspect of the invention, the geometry of plate 130 may vary from the geometry of magnets 128 in order to facilitate handling of plate 130 or facilitate the processing of a component mounted on film 118. For example, plate 130 may include one or more extensions, handles, or protrusions to facilitate placement or removal of plate 130, either manually or by automated means. Plate 130 may also include one or more perforations, holes, or pins to facilitate locating plate 130 on magnets 128.

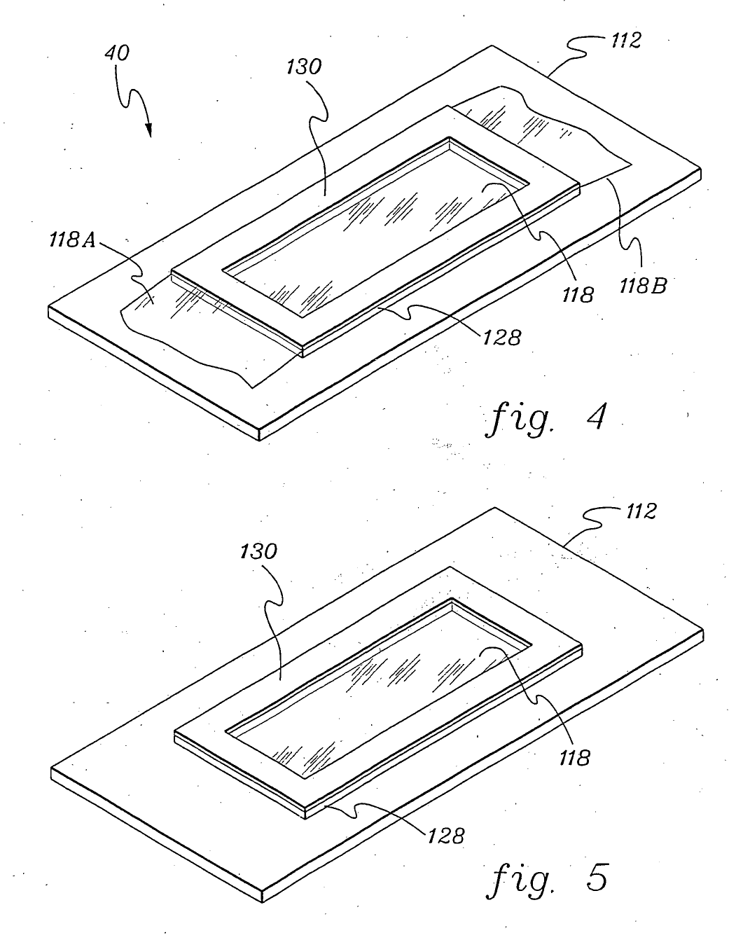

FIG. 4 illustrates a perspective view of fixture 40 shown in FIG. 3 as assembled with film 118 retained between plate 130 and magnets 128. As shown in FIG. 4, upon assembly of fixture 40, at least some excess film 118A and 118B may protrude beyond plate 130. According to one aspect of the invention, excess film 118A and 118B may be removed, either manually or via automated means, to provide the fixture 40 with mounted film 118 shown in FIG. 5 which, according to one aspect of the present invention, is now ready for further processing.

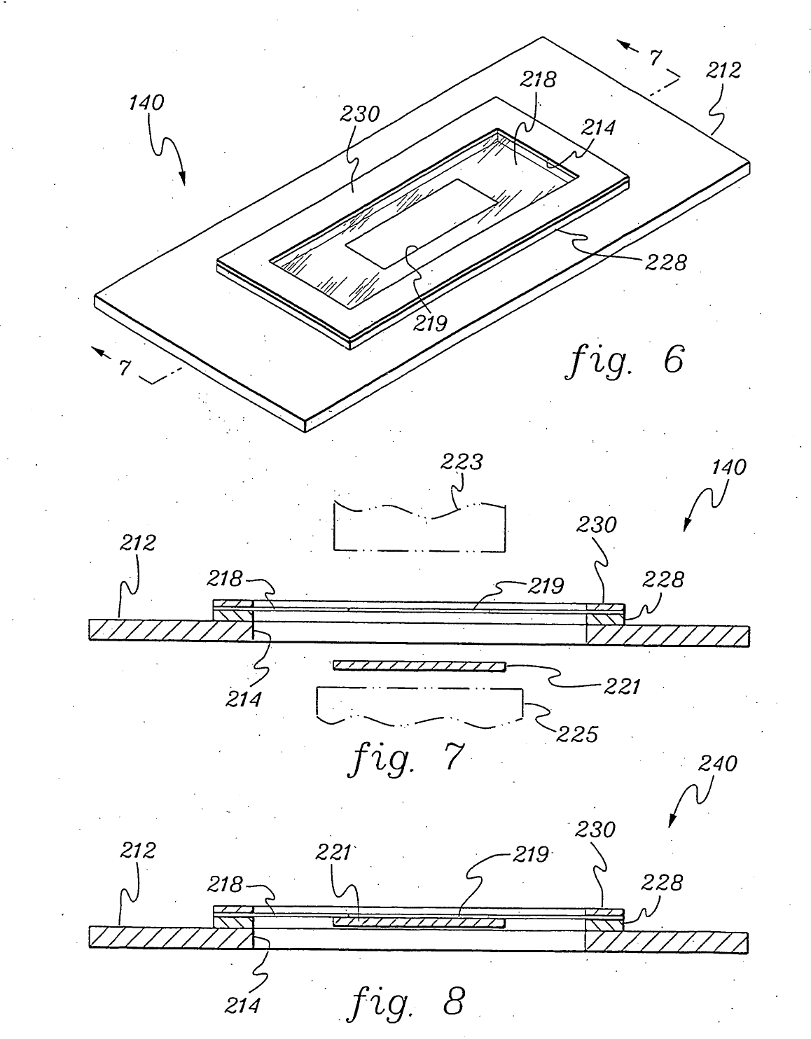

FIGS. 1 through 5 illustrate fixtures 10 and 40 which can be used to mount thin films 18, 118. According to the present invention, fixtures 10 and 40 can be used to facilitate the processing of thin films 18, 118, or the fabrication of components having a thin film 18, 118. FIGS. 6 through 15 illustrate one series of processes that can be practiced using fixtures 10 and 40. Though the processing described can be used for the fabrication of components of MEAs of fuel cells, those of skill in the art will recognize that many types of processing and fabrication may be facilitated by employing one or more aspects of the present invention.

FIG. 6 illustrates a perspective view of fixture 140 according to one aspect of the present invention. Fixture 140 is similar to fixture 40, having a plate 212 having an aperture 214, similar to plate 112; one or more magnets 228, similar to magnets 128; a ferro-magnetic plate 230, similar to plate 130; and a gasket 218, similar to thin film 118. Though the means for mounting gasket 218 shown in FIG. 6 comprises magnets 228 and ferro-magnetic plate 230, according to the present invention, any means of mounting gasket 218 to plate 212 in FIG. 6 may be used, for example, one of the means shown in FIGS. 2A, 2B, and 2C, among others.

According to one aspect of the invention, the fabrication of a component of an MEA includes the introduction of one or more openings, holes, or apertures 219 to gasket 218 by conventional means, for example, by manually cutting aperture 219 in gasket 218 or forming aperture 219 by means of a manual or automated die press. Aperture 219 may be any desired shape including polygonal, for example, quadrilateral, rectangular, triangular, and the like; or rounded, such as oval, ellipsoidal, circular, and the like. According to the aspect of the invention shown in FIG. 6, aperture 219 is rectangular in shape and is centrally located in aperture 214 in plate 212. Though only a single aperture 219 is shown in FIG. 6, according to one aspect of the invention, two or more apertures may be introduced to gasket 218. (See, for example, FIG. 16.)

In the next step in the fabrication of a component of a MEA according to one aspect of the invention, an electrode is introduced to aperture 219. This process is illustrated in FIG. 7. FIG. 7 illustrates a cross-sectional view of fixture 140 as viewed though section lines 7-7 shown in FIG. 6. FIG. 7 also includes a cross-sectional view of an electrode 221, for example, a carbon-based, gas-diffusion electrode provided by E-TEK of Somerset, N.J. According to one aspect of the invention, gasket 218 mounted in fixture 140 provides a gasket upon which electrode 221 is mounted. Electrode 221 may be mounted over aperture 219 in gasket 218 by conventional means, for example, by means of an adhesive. In one aspect of the invention, electrode 221 may be mounted over aperture 219 in gasket 218 by means of heat and pressure. For example, as shown in phantom in FIG. 7, heated die press 223 having an anvil 225 may be used to mount electrode 221 over aperture 219 in gasket 218. According to this aspect of the invention, electrode 221 is positioned as desired over aperture 219 (for example, positioned with a tolerance of 0.003 inches or less) and then die press 223 compresses the mating surfaces of electrode 221 and gasket 218, for example, about the periphery of aperture 219. According to one aspect of the invention, gasket 218 comprises a material that will adhere to electrode 221 when compressed with electrode 221 at temperature, for example, at a temperature of at least 100 degrees C. and a pressure of at least 100 psi. Under these temperature and pressure conditions gasket 218 fuses with electrode 221 wherein the gasket 218 is “welded” to electrode 221.

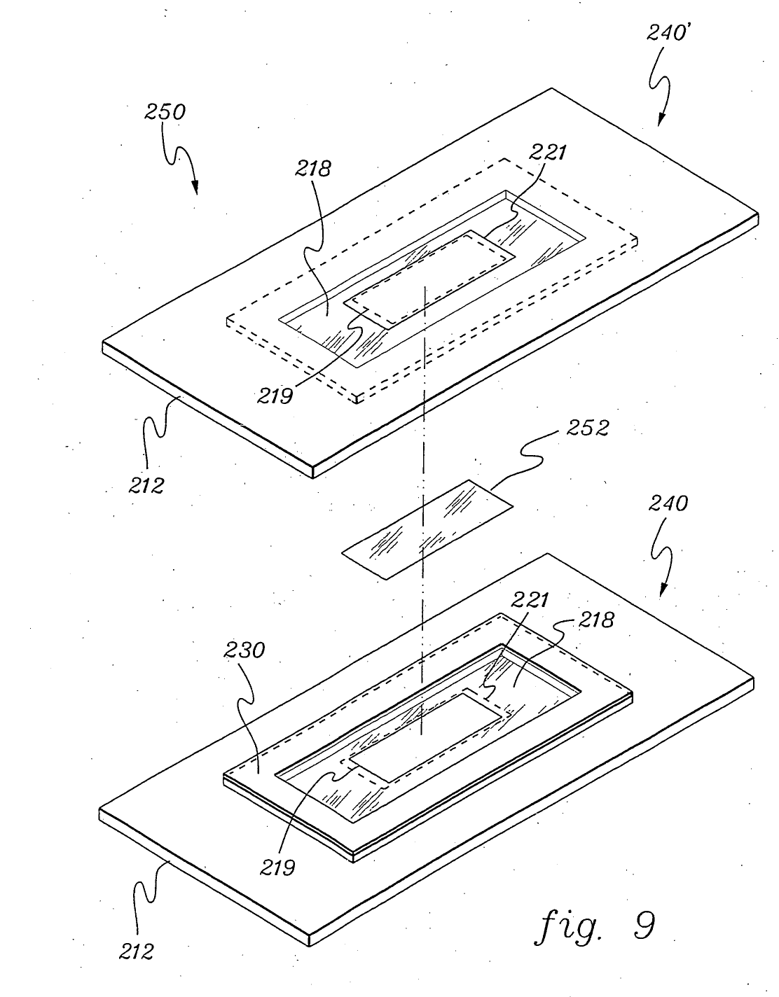

FIG. 8 is a cross-sectional view similar to FIG. 7, but showing the as-assembled fixture 240 having an electrode 221 over aperture 219 in gasket 218. According to one aspect of the invention, at least two fixtures 240 having gasket-mounted electrodes 221 are assembled with a membrane to provide an MEA for a fuel cell. The assembly of this MEA is illustrated in FIG. 9.

FIG. 9 is an exploded perspective view of an MEA assembly 250 according to one aspect of the present invention. Assembly 250 includes a first fixture 240 which is essentially identical to fixture 240 shown in FIG. 8, having an electrode 221 mounted on gasket 218 which in turn is mounted on plate 212. Assembly 250 includes a second fixture 240′ which is also essentially identical to fixture 240 shown in FIG. 8 but inverted. According to this aspect of the invention, an exchange membrane 252, for example, a proton exchange membrane (PEM), as is known in the art, is positioned between fixtures 240 and 240′ and aligned with electrodes 221, (again, for example, aligned with a tolerance of 0.003 inches or less). According to one aspect of the invention, exchange membrane 252 may be positioned between fixtures 240 and 240′ by means of the automated membrane handling method and apparatus disclosed in commonly-assigned U.S. patent application Ser. No. 10/232,424 filed on Aug. 30, 2002 and entitled “METHOD AND APPARATUS FOR TRANSFERRING THIN FILMS FROM A SOURCE POSITION TO A TARGET POSITION” (Attrny. Ref. 2036.001), the disclosure of which is included by reference herein in its entirety.

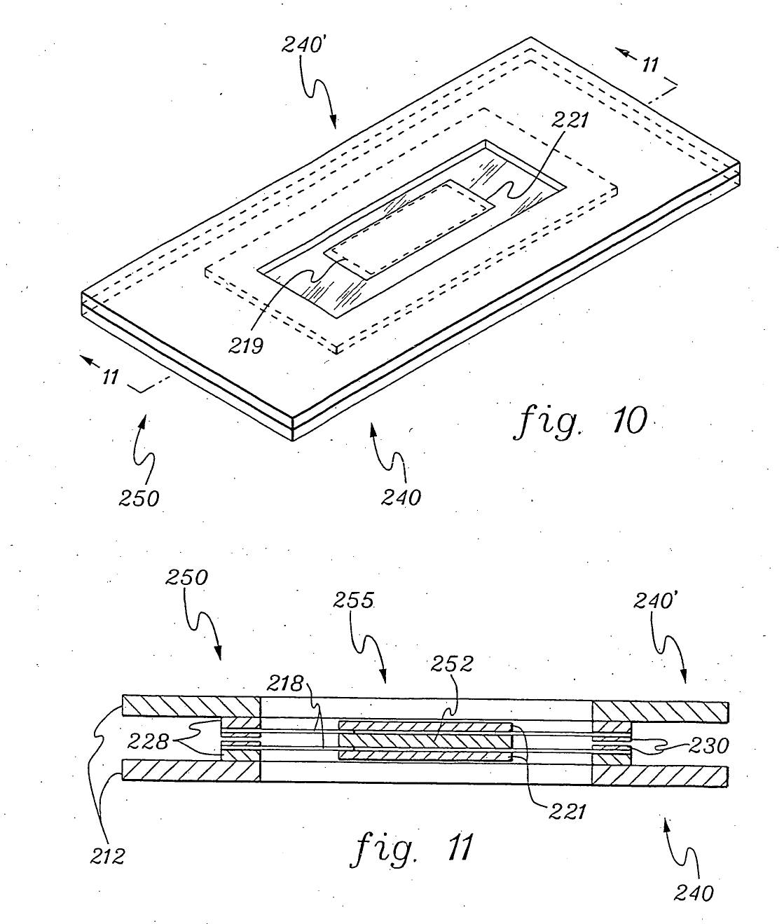

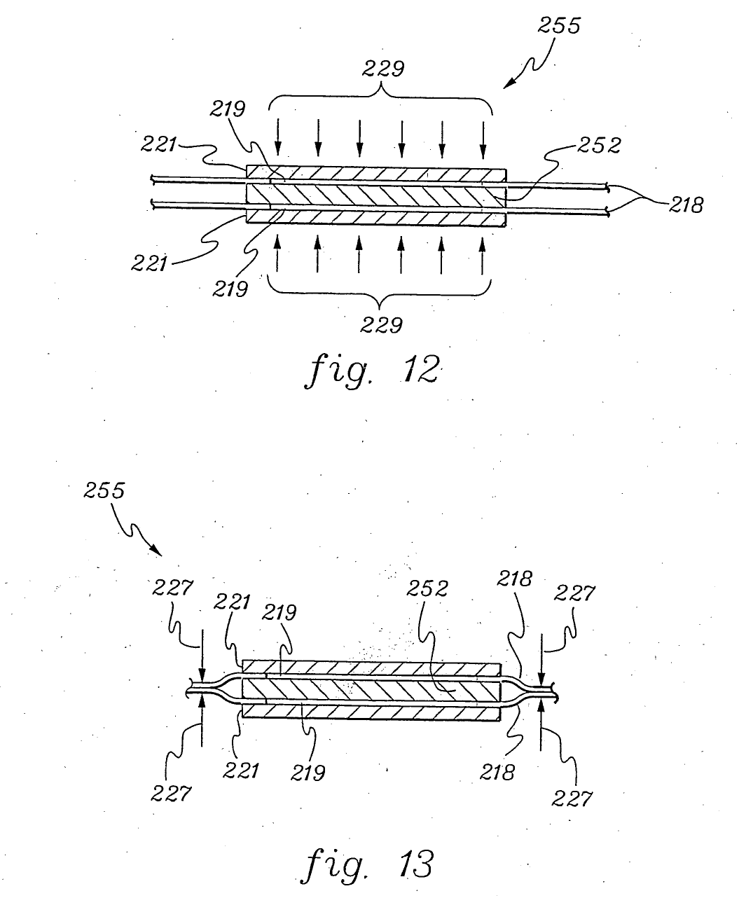

A perspective view of the assembly 250 having fixtures 240 and 240′ and membrane 252 is illustrated in FIG. 10. FIG. 11 illustrates a cross-sectional view of assembly 250 as viewed along lines 11-11 of FIG. 10. According to one aspect of the invention, the assembly of electrodes 221 and membrane 252 shown in FIG. 11 may be “sealed” by heating and compressing electrodes 221 and membrane 252 to form a sealed electrode-membrane-electrode assembly 255, as shown in FIG. 12. FIG. 12 illustrates a detailed view of the electrode-membrane-electrode assembly 255 shown in FIG. 11 during the sealing process. In one aspect of the invention, sealing may be effected by means of an adhesive. In another aspect of the invention, in a process similar to the process of attaching electrode 221 to gasket 218 shown in FIGS. 7 and 8, sealing is effected by compressing electrodes 221 and membrane 252, as shown by pressure distribution 229 in FIG. 12, and applying heat, for example, by means of a heated die press. According to one aspect of the invention, the sealing of the electrode-membrane-electrode assembly 255 may be practiced by applying a pressure of at least 100 psi at at least 100 degrees C. over the electrode-membrane-electrode assembly 255, for example, uniformly over the electrode-membrane-electrode assembly 255.

According to another aspect of the invention, after electrode-membrane-electrode assembly 255 has been sealed as shown in FIG. 12, electrode-membrane-electrode assembly 255 may be “laminated”. According to this aspect of the invention, and as used in the art, when electrode-membrane-electrode assembly 255 is laminated, mating gasket surfaces outside the periphery of electrodes 221 and membrane 252 of assembly 255 are fused. According to one aspect of the invention, lamination may be effected by applying an adhesive between the mating surfaces of gaskets 218. According to another aspect of the invention, lamination may be effected by means of heat and pressure in a die press in a fashion similar to the die press 223 shown in FIG. 7. FIG. 13 illustrates a detailed view similar to FIG. 12 of the electrode-membrane-electrode assembly 255 shown in FIG. 11 during lamination, that is, as the gaskets 218 about the periphery of the electrode-membrane-electrode assembly 255 are being fused. Arrows 227 represents the compression applied to gaskets 218 during the lamination process. Again, the pressure and temperature applied during lamination may be at least 100 psi at at least 100 degrees C.

According to another aspect of the invention, as shown in FIG. 14 one or more holes or perforations 260 may be introduced to the gasket 218. In one aspect of the invention, perforations 260 may by introduced after the electrode-membrane-electrode assembly 255 has been laminated, according to another aspect of the invention perforation 260 may be introduced at any time during the fabrication process. For example, perforations 260 may be introduced at about the same time aperture 219 is introduced in gasket 218, as shown in FIG. 6, or during sealing shown in FIG. 12, or during lamination shown in FIG. 13, or at any other time during processing. Perforations 260 may be provided to correspond with the passages in the assembled fuel cell, for example, the passages which supply and vent gases to the MEAs in the fuel cell such as electrode-membrane-electrode assembly 255. Perforations 260 may be provided in any desired number or shape and may be manually or automatedly cut into gaskets 218. In one aspect of the invention, perforations 260 are provided by one or more die-cut operations. In one aspect of the invention, perforations 260 may be omitted.

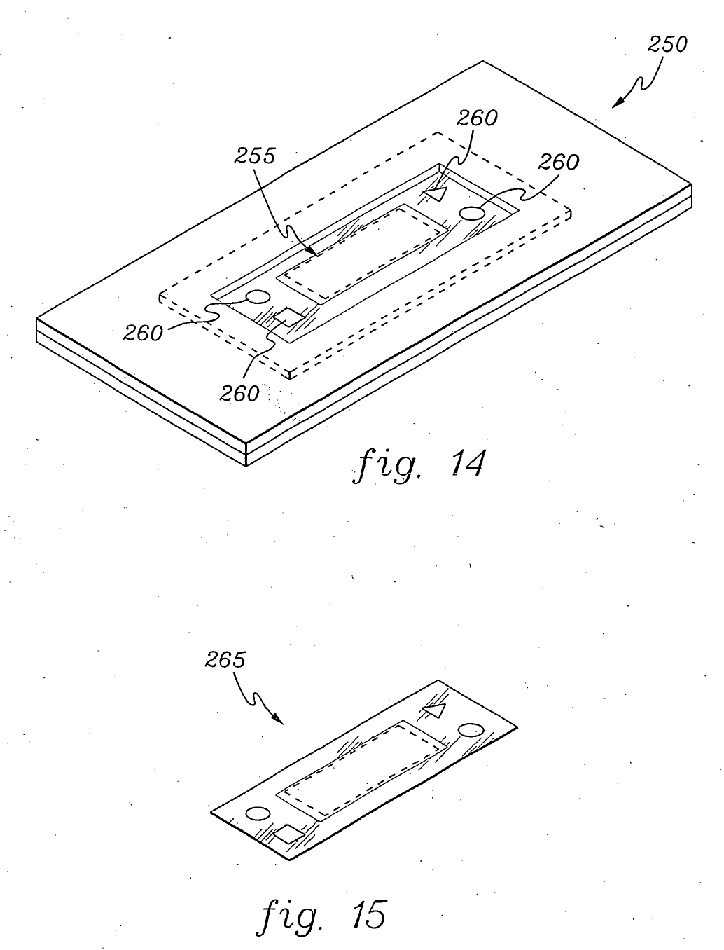

Upon completion of the handling of electrode-membrane-electrode assembly 255 in assembly 250, the electrode-membrane-electrode assembly 255 may be removed from assembly 250 and trimmed to a desired shape to provide the essentially completed electrode-membrane-electrode assembly 265 as shown in FIG. 15. The removal of electrode-membrane-electrode assembly 255 from assembly 250 may be effected manually or automatedly, for example, in a single die-cut operation. The completed electrode-membrane-electrode assembly 265 with integral gasket may then be inserted into a fuel-cell stack or otherwise handled, or packaged for storage or shipping.

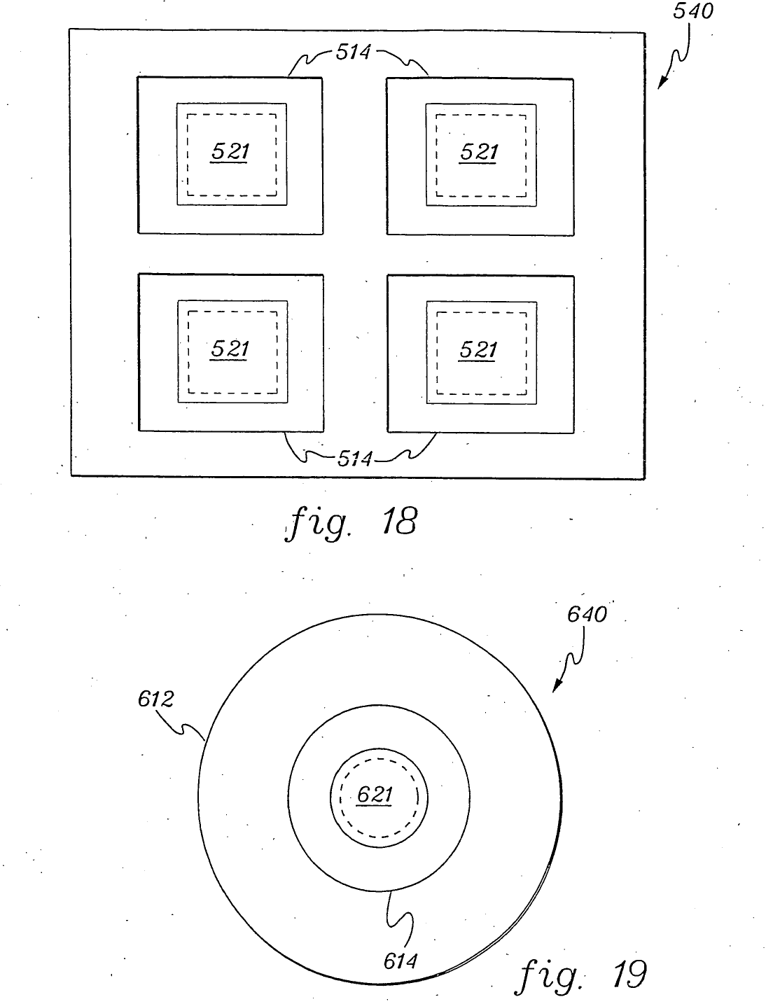

Though according to one aspect of the invention, fixture 240 in FIG. 9 includes a single aperture 214 in plate 212 and a single electrode 221, according to the aspects of the invention shown in FIGS. 16, 17, and 18, more than one aperture 214 and more than one electrode 221 may be provided. For example, FIG. 16 illustrates fixture 340 having a single aperture 314 having two or more electrodes 321 according to another aspect of the invention. FIG. 17 illustrates fixture 440 having two or more apertures 414, each aperture 414 having one or more electrodes 421 according to another aspect of the invention. FIG. 18 illustrates fixture 540 having four or more apertures 514, each aperture 514 having one or more electrodes 521 according to another aspect of the invention. In addition, according to one aspect of the invention, plate 212 and aperture 214 shown FIG. 6 may be provided in any desired shape, for example, depending upon the shape of the fuel cell into which the MEA is to be used. For example, as shown in FIG. 19, in one aspect of the invention, a fixture 640 may have a circular plate 612 and a circular aperture 614 and have one or more circular or quadrilateral electrodes 621 (which may be mated with one or more corresponding circular or quadrilateral membranes).

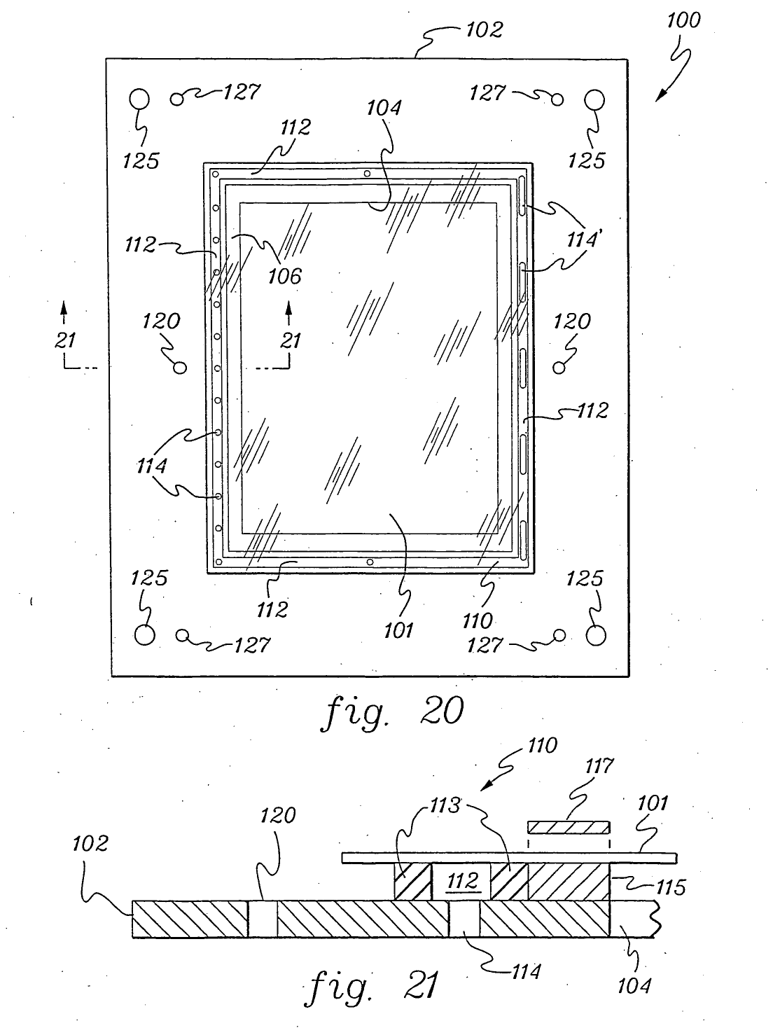

According to another aspect of the invention, fixture 240, and related fixtures, may be provided with means to facilitate mounting the thin film over the aperture in the plate. One such fixture 100 for mounting a thin film 101 is shown in FIG. 20. Fixture 100 includes a plate 102 which may have one or more characteristics of plates 12, 212 discussed above, including an aperture 104; and a means 106 for mounting thin film 101, which may be similar to means 16, 16A, 16B, or 16C disclosed above. For illustrative purposes means 106 shown in FIG. 20 comprises the magnetic means 16B shown in FIG. 2B. According to this aspect of the invention, fixture 100 also includes a means 110 for facilitating the handling and mounting of thin film 101 to fixture 100. According to one aspect of the invention, means 110 comprises a vacuum channel 112 operatively connected to a source of vacuum (not shown). In one aspect of the invention, vacuum channel 112 is operatively connected to a source of vacuum by means of one or more vacuum apertures 114. Vacuum apertures 114 may be circular holes, rectangular holes or slots, rounded slots 114′, or a combination of apertures of different shape, among other shapes of apertures.

A detailed view of means 110 is shown in FIG. 21. FIG. 21 is a cross sectional view as viewed along lines 21-21 in FIG. 20. As shown in FIG. 21, plate 102 of fixture 100 for mounting thin film 101 includes a magnetic strip 115 mounted about aperture 104 and a ferro-magnetic plate 117 which is used with magnetic strip 115 to retain thin film 101. As also shown in FIG. 21, fixture 100 also includes a vacuum channel 112 which is operatively connected to a source of vacuum (not shown) by means of one or more vacuum holes 114. Vacuum channel 112 may be provided by two barriers 113 mounted to plate 102. In one aspect of the invention, barriers 113 may be integral with plate 102, for example, formed or molded into the surface of plate 102. In another aspect of the invention, barriers 113 may be separate structures mounted to the surface of plate 102, for example, by mechanical fasteners, welding, or adhesives. In one aspect of the invention, barriers 113 may be metallic, for example, steel or aluminum; or non-metallic, for example, elastomeric or polymeric, such as rubber barriers. In one aspect of the invention, one barrier 113 may comprise the edge of magnetic strip 115. In another aspect of the invention, at least one barrier 113 may be magnetic, and at least one barrier 113 may supplement or replace the function of magnetic strip 115. For example, in one aspect of the invention, ferro-magnetic plate 117 may extend over at least one of the magnetic barriers 113 and be retained by at least one of the magnetic barriers 113. In another aspect of the invention, one or more magnetic barriers 113 may replace magnetic strip 115, whereby magnetic strip 115 may be omitted, for example, one or more magnetic barriers 113 may be positioned in the location of magnetic strip 115 in FIG. 21 whereby magnetic strip 115 may be omitted.

According to one aspect of the invention, thin film 101 is drawn over aperture 104, for example, manually or automatedly, and the source of vacuum is actuated (again, either manually or automatedly) wherein a vacuum is drawn through one or more holes 114 and into vacuum channel 112. The vacuum in vacuum channel 112 draws thin film 101 over vacuum channel 112 to retain thin film 101 in place over aperture 104 and magnetic strip 115. While the thin film 101 is retained by vacuum, ferro-magnetic plate 117 may be positioned over magnetic strip 115 (again, manually or automatedly) to retain thin film 101 over aperture 104. The source of vacuum to vacuum channel 112 may then be shut off and fixture 100 with thin film 101 can be handled or processed as needed. Vacuum channel 112 may be used in any one of the fixtures disclosed in this specification.

According to another aspect of the present invention, as shown in FIG. 20, fixture 100 (or any other fixture disclosed in this specification) may include one or more fixture positioning apertures 120. Apertures 120 may be holes, slots, grooves, or related structures used to align fixture 100 during the handling and processing of thin films or components mounted on fixture 100. For example, as shown in FIG. 20, fixture 100 may include at least two positioning holes 120 having a diameter between about 0.125 inches and about 0.75 inches. Holes 120 may cooperate with similarly sized pins or dowels positioned in the stations which process the thin film or components mounted on the thin film, for example, pins or dowels positioned in die presses. When wear of plate 102 is a concern, holes 120 may be reinforced by means of a bushing or grommet to reduce wear or provide a wear-resistance surface.

According to another aspect of the invention, fixture 100 (or any other fixture disclosed in this specification) may include handling apertures 125 and 127. Again, apertures 125 and 127 may be holes, slots, grooves, or related structures used to facilitate handling of fixture 100 during the processing of thin films or components mounted on fixture 100. For example, in one aspect of the invention, apertures 125 and 127 may be used to retain fixture 100 pins or dowels on a conveyor, for example, on a walking-beam conveyor, though other types of conveyors may be used. Apertures 125 and 127 may have a diameter between about 0.125 inches and about 1.00 inches.

According to another aspect of the invention, fixture 100 (or any other fixture disclosed in this specification) may include one or more handles for manually carrying or manipulating fixture 100. The handles may simply comprise one or more through holes in plate 102 or bars, ribs, or commercially-available handles mounted onto the surface of plate 102.

The present invention provides fixtures and methods of using fixtures which facilitate the handling of thin films during the process of fabricating devices having thin films, for example, components of Membrane Electrode Assemblies. The present invention is especially useful when automating the assembly of such devices, which according to prior art methods, can typically only be processed individually by hand. The present invention facilitates the manufacture of such devices wherein such devices can be produced more quickly and more economically than when using prior art fixtures or methods. Thus, by employing aspects of the present invention, such devices can be made commercially available at reasonable cost where otherwise such devices would be too expensive to commercially produce.

While the invention has been particularly shown and described with reference to preferred embodiment, it will be understood by those skilled in the art that various changes in form and details may be made to the invention without departing from the spirit and scope of the invention described in the following claims.

1. A fixture for facilitating the fabrication of a fuel-cell membrane electrode assembly, the fixture comprising:
a plate having an aperture; and
means for mounting a gasket to the plate wherein the gasket at least partially obstructs the aperture;
wherein the portion of the gasket that at least partially obstructs the aperture provides a surface for mounting at least one electrode for a fuel-cell membrane electrode assembly.

2. The fixture as recited in claim 1, wherein the means for mounting the gasket to the plate comprises means for detachably mounting the gasket to the plate.

3. The fixture as recited in claim 1, wherein the means for mounting the gasket to the plate comprises at least one of mechanical means, adhesive means, magnetic means, and vacuum means.

4. The fixture as recited in claim 1, wherein the means for mounting the gasket to the plate comprises at least one magnet.

5. The fixture as recited in claim 4, wherein the means for mounting the gasket to the plate further comprises at least one ferro-magnetic plate mounted to the at least one magnet.

6. The fixture as recited in claim 4, wherein the fixture further comprises at least one vacuum aperture in the plate operatively connected to a source of vacuum.

7. The fixture as recited in claim 6, wherein the fixture further comprises at least one vacuum channel in fluid communication with the at least one vacuum aperture.

8. The fixture as recited in claim 1, wherein the plate comprises a plate having a thickness of less than about 0.25 inches.

9. The fixture as recited in claim 8, wherein the plate comprises at least one of a metallic and a non-metallic material.

10. The fixture as recited in claim 9, wherein the non-metallic material comprises a composite material.

11. The fixture as recited in claim 1, wherein the gasket comprises a thin-film gasket having a thickness less than about 500 microns.

12. A method for facilitating the fabrication of fuel-cell membrane electrode assemblies using a fixture comprising a first plate having an aperture, the method comprising;
a) providing a thin-film gasket;
b) mounting the thin-film gasket to the first plate wherein the thin-film gasket at least partially obstructs the aperture;
c) introducing an aperture to the thin-film gasket; and
d) mounting an electrode over the aperture in the thin-film gasket to provide a first gasketed electrode mounted in the first plate;
wherein the gasketed electrode is used in a fuel-cell membrane electrode assembly.

13. The method as recited in claim 12, wherein the first plate further comprises means for attaching the thin-film gasket to the first plate, and wherein b) mounting the thin-film gasket to the first plate comprises mounting the thin-film gasket using the means for attaching the thin film gasket to the first plate.

14. The method as recited in claim 12, wherein c) introducing an aperture in the thin-film gasket comprises introducing a quadrilateral aperture in the thin-film gasket.

15. The method as recited in claim 12, wherein c) introducing an aperture in the thin-film gasket comprises introducing a plurality of apertures in the thin-film gasket.

16. The method as recited in claim 12, wherein c) introducing an aperture in the thin-film gasket comprises die-cutting the aperture in the thin-film gasket.

17. The method as recited in claim 12, wherein d) mounting the electrode over the aperture in the thin-film gasket comprises d1) overlapping at least a portion of the electrode and the thin-film gasket, and d2) heating and compressing the overlapped portion to provide adhesion between the overlapped portion of the thin-film gasket and the overlapped portion of the electrode.

18. The method as recited in claim 17, wherein d2) heating and compressing comprises heating to at least about 100 degrees C. and compressing to at least about 100 psi.

19. The method as recited in claim 12, further comprising repeating steps a) through d) to provide a second gasketed electrode mounted in a second plate.

20. The method as recited in claim 19, further comprising positioning an exchange membrane between the first gasketed electrode and the second gasketed electrode and sealing the first gasketed electrode and the second gasketed electrode about the exchange membrane to produce a sealed gasketed electrode-membrane-electrode assembly.

21. The method as recited in claim 20, wherein sealing comprises exposing the first gasketed electrode and the second gasketed electrode to temperature and pressure wherein the first gasketed electrode and the second gasketed electrode adhere to the exchange membrane.

22. The method as recited in claim 20, further comprising laminating the sealed gasketed electrode-membrane-electrode assembly.

23. The method as recited in claim 22, wherein laminating comprises exposing at least a portion of the gaskets of the first gasketed electrode and the second gasketed electrode to temperature and pressure wherein the portion of the gaskets adhere to each other.

24. The method of claim 20 further comprising introducing at least one aperture to the gasket of the sealed gasketed electrode-membrane-electrode assembly to provide a passage for a gas when assembled in a fuel cell stack.

25. The method of claim 20 further comprising positioning the sealed gasketed electrode-membrane-electrode assembly in a fuel cell stack.

26. A fixture for facilitating the fabrication of devices having thin films, the fixture comprising:
a plate having an aperture; and
means for mounting a thin film to the plate wherein the thin film at least partially obstructs the aperture;
wherein the portion of the thin film that at least partially obstructs the aperture provides a surface for mounting at least one component of the device.

27. The fixture as recited in claim 26, wherein the means for mounting the thin film to the plate comprises means for detachably mounting the thin film to the plate.

28. The fixture as recited in claim 26, wherein the means mounting the thin film to the plate comprises at least one of mechanical means, magnetic means, and vacuum means.

29. The fixture as recited in claim 26, wherein the means for mounting the thin film to the plate comprises at least one magnet.

30. The fixture as recited in claim 29, wherein the means for mounting the thin film to the plate further comprises at least one ferro-magnetic plate mounted to the at least one magnet.

31. The fixture as recited in claim 29, wherein the fixture further comprises at least one vacuum aperture in the plate operatively connected to a source of vacuum.

32. The fixture as recited in claim 31, wherein the fixture further comprises at least one vacuum channel in fluid communication with the at least one vacuum aperture.

33. The fixture as recited in claim 26, wherein the plate comprises a plate having a thickness of less than about 0.25 inches.

34. The fixture as recited in claim 33, wherein the plate comprises at least one of a metallic and a non-metallic material.

35. The fixture as recited in claim 34, wherein the non-metallic material comprises a composite material.

36. The fixture as recited in claim 26, wherein the thin film comprises a thin-film having a thickness less than about 500 microns.

37. A method for facilitating the fabrication of devices having thin films using a fixture comprising a plate having an aperture, the method comprising;
a) providing the thin film;
b) mounting the thin-film to the plate wherein the thin film at least partially obstructs the aperture;
c) mounting at least one component of the device on the thin film to provide a component with a thin film supported by the plate;
d) exposing the component with a thin film to further processing while supported by the plate; and
e) mounting the component with the thin film in the device.

38. The method as recited in claim 37, further comprising f) introducing at least one aperture to the thin film.

39. The method as recited in claim 37, wherein the plate further comprises means for attaching the thin film to the plate, and wherein b) mounting the thin film to the plate comprises mounting the thin film using the means for attaching the thin film to the plate.

40. The method as recited in claim 37, wherein the plate further comprises at least one magnet, and wherein b) mounting the thin film to the plate comprises positioning the thin film over the at least one magnet and placing a ferro-magnet plate over the thin film and the at least one magnet.

41. The method as recited in claim 37, wherein c) mounting at least one component of the device on the thin film comprises c1) overlapping at least a portion of the component and the thin-film, and c2) heating and compressing the overlapped portion to provide adhesion between the overlapped portion of the thin-film and the overlapped portion of the component.

42. The method as recited in claim 41, wherein c2) heating and compressing comprises heating to at least about 100 degrees C. and compressing to at least about 100 psi.
